(19) United States
(12) Patent Application Publication
(10) Pub. No.: US 2025/0214757 A1
(43) Pub. Date: Jul. 3, 2025

(54) ALCOHOLIC BEVERAGE FLAVORING CONTAINER

(71) Applicant: Christopher Singleton, Louisville, KY (US)

(72) Inventor: Christopher Singleton, Louisville, KY (US)

(21) Appl. No.: 18/396,783

(22) Filed: Dec. 27, 2023

(51) Int. Cl. B65D 51/28; B65D 8/00; C12G 3/07

(52) U.S. Cl. CPC B65D 51/2857; B65D 9/02; C12G 3/07

(57) ABSTRACT

A container for flavoring an alcoholic beverage includes a body having an interior volume. The body includes a bottom section, a sidewall disposed about a perimeter of the bottom section, and a lid section affixed to the sidewall. The container also includes at least one retaining device positioned within the interior volume of the container. Each of the at least one retaining device is configured to retain at least one flavoring agent for suspension of the at least one flavoring agent in the alcoholic beverage when the container is at least partially filled with the alcoholic beverage.

### FIELD OF THE INVENTION

The disclosure relates generally to beverage flavoring containers, and more particularly, to containers that have flavoring agents for submerging in an alcoholic beverage.

### BACKGROUND

Beverages, specifically alcoholic beverages, are very popular among the world population. In many instances of creating an alcohol, a flavoring process is carried out that gives specific alcohols their unique flavor. Generally, this process takes years for certain alcoholic beverage to attain its distinct flavor. A prime example of an alcoholic beverage that utilizes this process is whiskey, which a lot of times is recognized by its “age” (5 year, 10 year, 20 year, etc.). Most of these “aging” processes require a substantial amount of time.

### BRIEF DESCRIPTION OF THE DRAWINGS

For a more complete understanding of the features and advantages of the present disclosure, reference is now made to the detailed description along with the accompanying figures in which corresponding numerals in the different figures refer to corresponding parts and in which:

FIG. 1 is an illustration of a generic barrel for storing an alcoholic beverage;

FIG. 2A is an illustration of a diagrammatic view of a beverage flavoring container and flavoring agents in accordance with certain embodiments of the present disclosure;

FIG. 2B is an illustration of a perspective view of a beverage flavoring container housing a plurality of flavoring agents in accordance with certain embodiments of the present disclosure;

FIG. 2C is an illustration of a perspective view of a beverage flavoring container housing a plurality of flavoring agents and including a lid section in accordance with certain embodiments of the present disclosure;

FIG. 3 is an illustration of a perspective view of a beverage flavoring container including a plurality of retaining devices positioned on a rim of the beverage flavoring container in accordance with certain embodiments of the present disclosure;

FIG. 4A is an illustration of a perspective view of a beverage flavoring container including a retaining device affixed to a lid section of the beverage flavoring container in accordance with certain embodiments of the present disclosure;

FIG. 4B is an illustration of a deconstructed view of a beverage flavoring container in accordance with certain embodiments of the present disclosure;

FIG. 4C is an illustration of a perspective view of a beverage flavoring container including a retaining device affixed to a cover portion of a lid section of the beverage flavoring container in accordance with certain embodiments of the present disclosure;

FIG. 4D is an illustration of a deconstructed view of a beverage flavoring container in accordance with certain embodiments of the present disclosure;

FIG. 5A is an illustration of a perspective view of an open beverage flavoring container including an alternative flavoring agent positioned in the alcoholic beverage container in accordance with certain embodiments of the present disclosure;

FIG. 5B is an illustration of a perspective view of a beverage flavoring container including an alternative flavoring agent affixed to a lid section and positioned in the alcoholic beverage container in accordance with certain embodiments of the present disclosure;

FIG. 5C is an illustration of a deconstructed view of a beverage flavoring container including a lid section and an alternative flavoring agent removed from the beverage flavoring container in accordance with certain embodiments of the present disclosure;

FIG. 6A is an illustration of a zoomed-in view of a beverage flavoring container including an inlet tubing having an orifice in accordance with certain embodiments of the present disclosure;

FIG. 6B is an illustration of a zoomed-in view of a beverage flavoring container including a lid section having an airlock in accordance with certain embodiments of the present disclosure;

FIG. 7A is an illustration of a perspective view of a flavoring agent in accordance with certain embodiments of the present disclosure;

FIG. 7B is an illustration of a perspective view of an alternative flavoring agent embodying a lattice structure in accordance with certain embodiments of the present disclosure;

FIG. 8 is an illustration of a perspective view of a filter apparatus for flavoring an alcoholic beverage in accordance with certain embodiments of the present disclosure;

FIG. 9 is an illustration of a perspective view of an alternative filter apparatus for flavoring an alcoholic beverage in accordance with certain embodiments of the present disclosure;

FIG. 10 is an illustration of a perspective view of an alternative beverage flavoring container including a retaining device affixed to a lid section of the beverage flavoring container in accordance with certain embodiments of the present disclosure;

FIG. 11 is an illustration of a perspective view of an alternative beverage flavoring container in accordance with certain embodiments of the present disclosure;

FIG. 12 is an illustration of a flowchart presenting an alternative method for flavoring an alcoholic beverage in accordance with certain embodiments of the present disclosure; and

FIG. 13, which is an illustration of a flowchart presenting an alternative method for flavoring an alcoholic beverage in accordance with certain embodiments of the present disclosure.

The illustrated figures are only exemplary and are not intended to assert or imply any limitation with regard to the environment, architecture, design, or process in which different examples may be implemented.

### DETAILED DESCRIPTION

The disclosure relates generally to beverage flavoring containers, and more particularly, to containers that have retaining devices for retaining flavoring agents in an alcoholic beverage. The term “beverage” is used herein to describe any liquid that is intended for human consumption. In multiple embodiments herein, the term “beverage” refers to an alcoholic beverage. The term “flavoring agent” is used herein to describe any substance capable of releasing molecules when suspended in a beverage over a period of time for the purposes of adding flavor to a beverage. The term “flavoring session” is used herein to describe a time period during which an alcoholic beverage is flavored within a container. The term “retaining device” is used herein to describe a device with an interior volume that is utilized to hold and at least partially suspend a flavoring agent in an alcoholic beverage.

While the making and using of various embodiments of the present disclosure are discussed in detail below, it should be appreciated that the present disclosure provides many applicable inventive concepts, which can be embodied in a wide variety of specific contexts. The specific embodiments discussed herein are merely illustrative and do not delimit the scope of the present disclosure. In the interest of clarity, not all features of an actual implementation may be described in the present disclosure.

Presented herein is a container for flavoring an alcoholic beverage. The beverage flavoring container comprises a body having an interior volume and further includes a bottom section, a sidewall disposed about a perimeter of the bottom section, and a lid section affixed to the sidewall. The beverage flavoring container further includes at least one flavoring agent positioned within the interior volume of the container.

Additionally presented herein is a filter apparatus for flavoring an alcoholic beverage. The apparatus comprises a housing and a filter positioned within the housing, where the filter comprises at least one flavoring agent configured to release molecules into the alcoholic beverage that are configured to provide flavor to the alcoholic beverage.

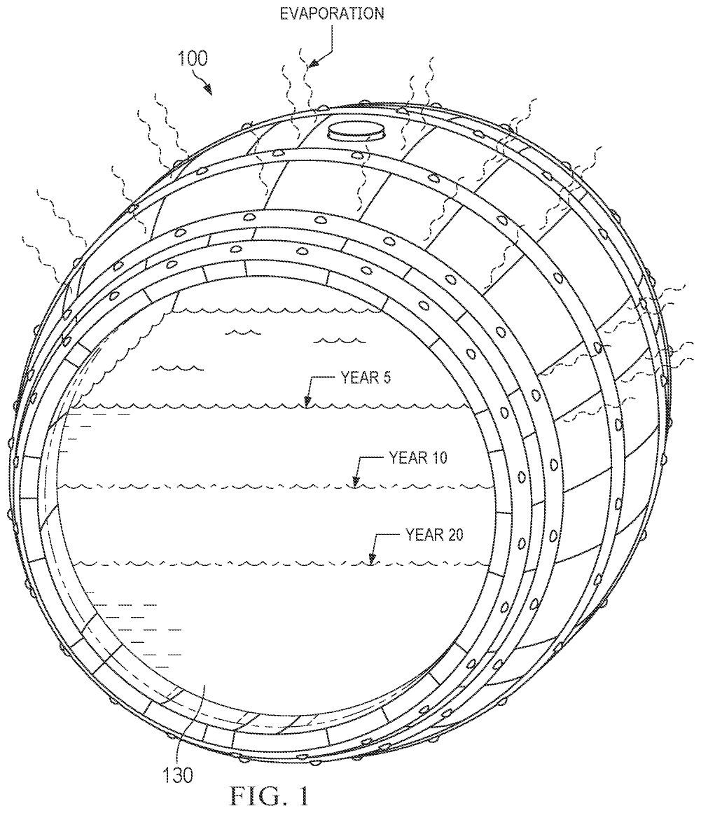

FIG. 1 is an illustration of a generic barrel 100 for storing an alcoholic beverage 130. In regards to the process of aging alcohols, barrel 100 stores an alcoholic beverage 130 for a certain number of years (as shown, for example, 5 years, 10 years, 20 years). Over those time periods, a certain volume of alcohol is lost due to evaporation. Typically, the longer an alcohol is aged, the more volume of the alcohol is lost to evaporation.

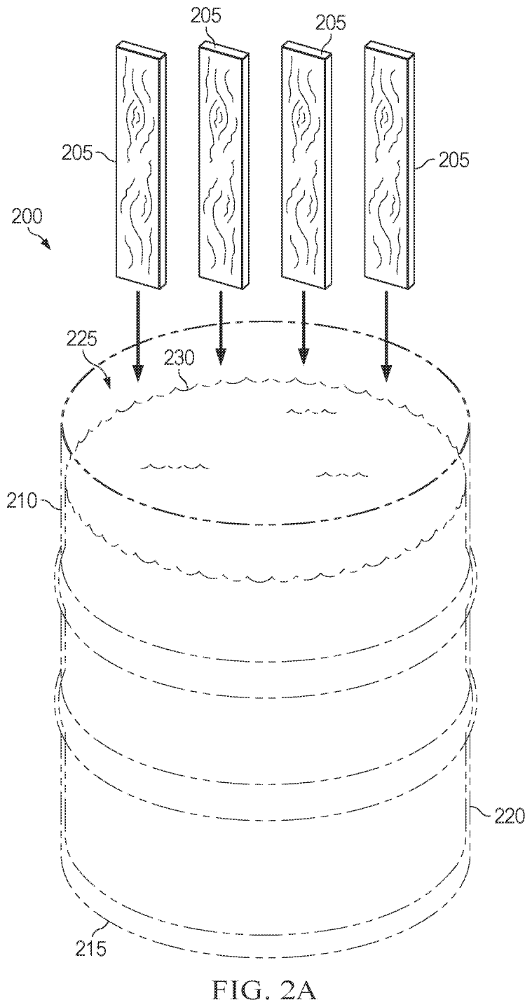

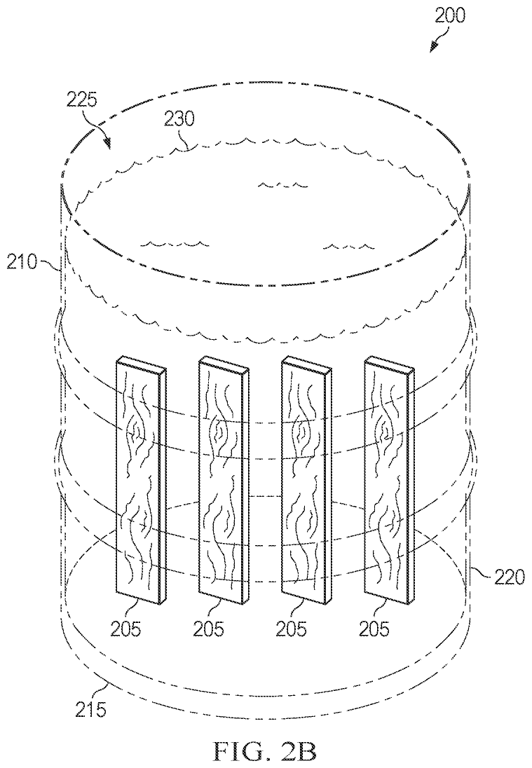

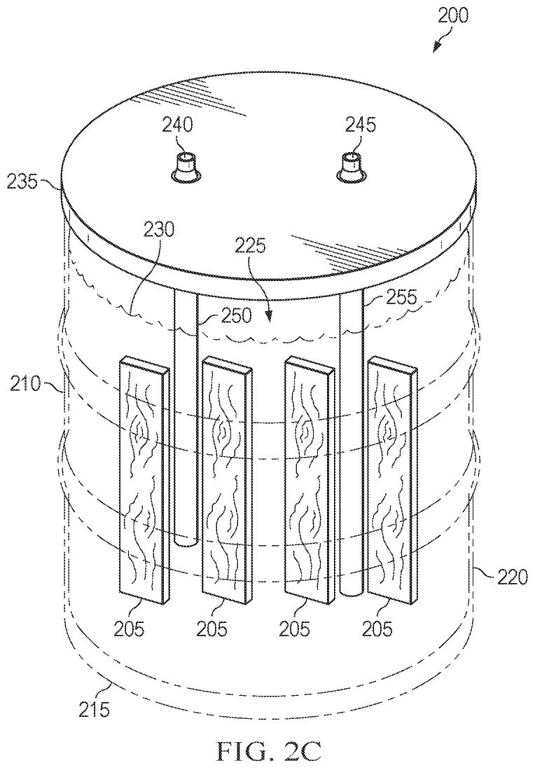

FIG. 2A illustrates a diagrammatic view of a beverage flavoring container 200 and flavoring agents 205 in accordance with certain embodiments of the present disclosure. In the depicted embodiment, a body 210 of beverage flavoring container 200 includes a bottom section 215 and a sidewall section 220 disposed about a perimeter of the bottom section 215. An interior volume 225 of beverage flavoring container 200 contained within body 210 is filled with an alcoholic beverage 230 and is open at its top side. As shown, beverage flavoring container 200 is configured to receive one or more flavoring agents 205 (as depicted, pieces of wood). As shown in FIG. 2B, the one or more flavoring agents 205 are suspended within the alcoholic beverage 230. Once the alcoholic beverage 230 receives the flavoring agents 205, the process of flavoring the alcoholic beverage 230 begins. As further shown in FIG. 2C, a lid section 235 is affixed to the top side of sidewall section 220, enclosing the flavoring agents 205 and the alcoholic beverage 230 within beverage flavoring container 200.

In order to add and remove volume of the alcoholic beverage 230 to and from beverage flavoring container 200, an inlet orifice 240 and an outlet orifice 245 is positioned on lid section 235. As shown, inlet orifice 240 includes an inlet tubing 250 being disposed about a perimeter of the inlet orifice 240 and extending into the interior volume 225 of beverage flavoring container 200 from inlet tubing 250, while outlet orifice 245 includes an outlet tubing 255 being disposed about a perimeter of the outlet orifice 245 and extending into the interior volume 225 of beverage flavoring container 200 from outlet tubing 255.

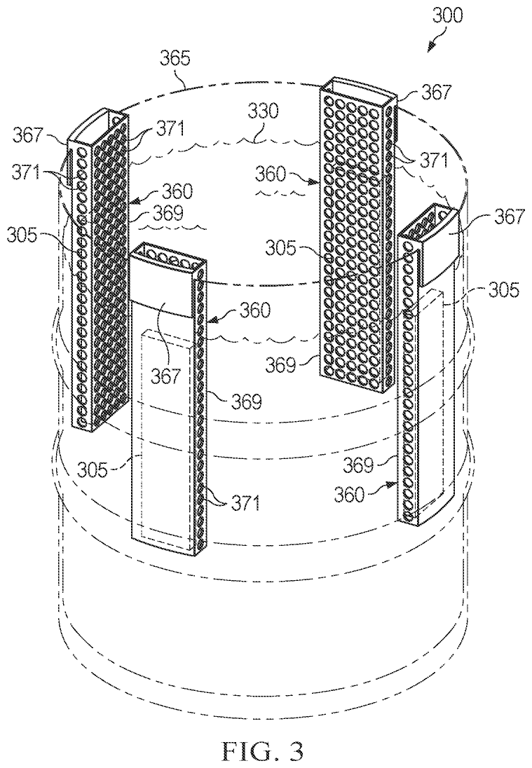

FIG. 3 illustrates a perspective view of a beverage flavoring container 300 including a plurality of retaining devices 360 positioned on a rim 365 of the beverage flavoring container 300 in accordance with certain embodiments of the present disclosure. As shown, beverage flavoring container 300 is open at the top and includes an exposed rim 365. The plurality of retaining devices 360 include hooked ends 367 that allow retaining devices 360 to be removably attachable to rim 365. A body portion 369 of each of the retaining devices 360 includes an interior volume that retains one or more flavoring agents 305 and a plurality of orifices 371 positioned along each of the body portions 369. The configuration of the retaining devices 360 allows flavoring agents 305 to be at least partially suspended within an alcoholic beverage 330 when retaining devices 360 are positioned on rim 365.

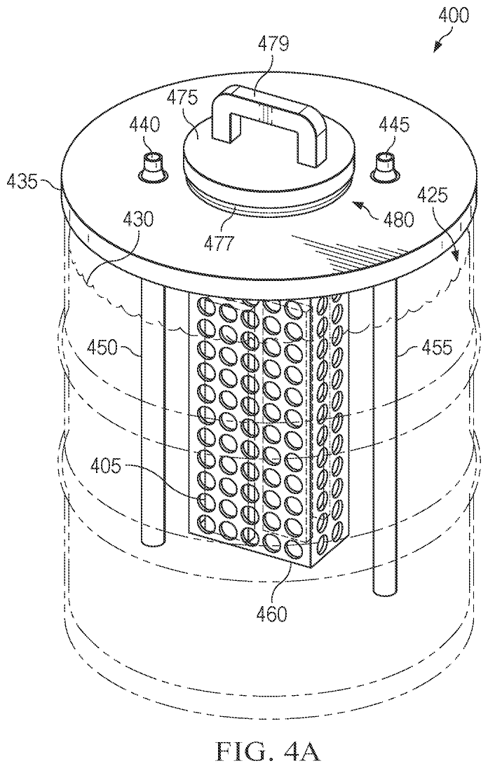

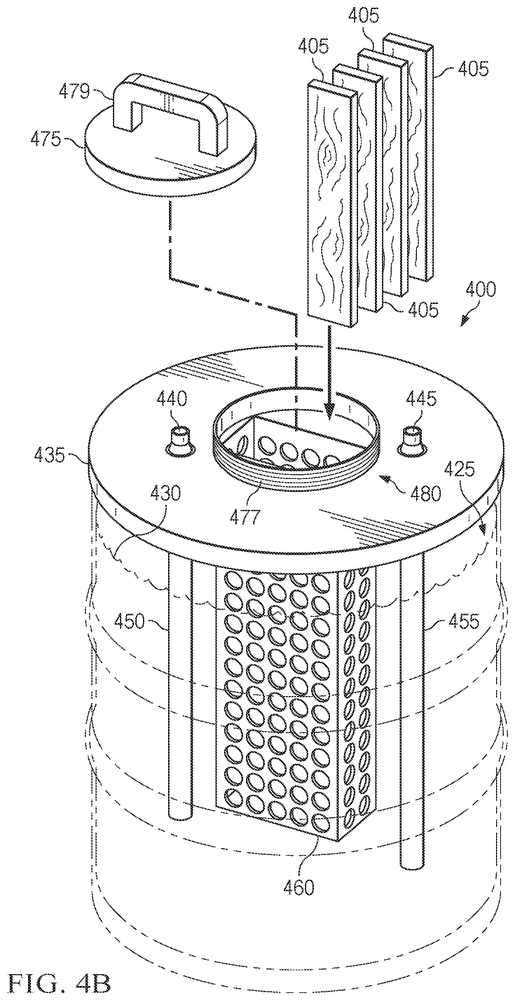

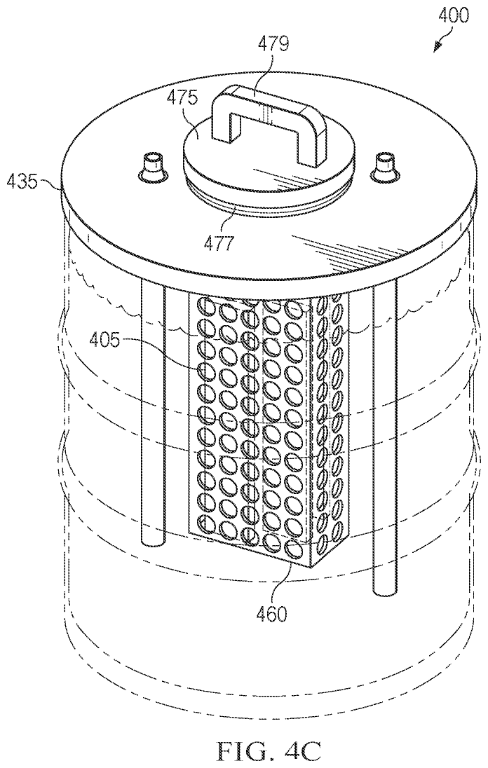

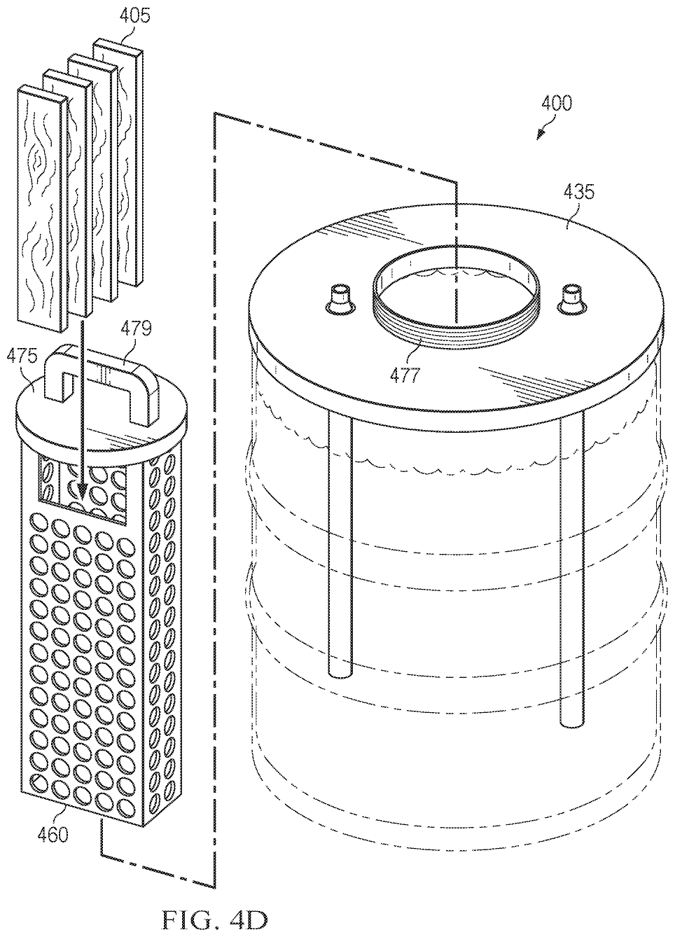

FIG. 4A illustrates a perspective view of a beverage flavoring container 400 including a retaining device 460 affixed to a lid section 435 of the beverage flavoring container 400 in accordance with certain embodiments of the present disclosure. It is noted that beverage flavoring container 400 includes components and features similar to that of containers 200,300 of FIGS. 2A-2C and 3, unless otherwise specified below. As shown (and similarly to FIG. 2C), an inlet orifice 440 and an outlet orifice 445 is positioned on lid section 435. Inlet orifice 440 includes an inlet tubing 450 being disposed about a perimeter of the inlet orifice 440 and extending into the interior volume 425 of beverage flavoring container 400 from inlet tubing 450, while outlet orifice 445 includes an outlet tubing 455 being disposed about a perimeter of the outlet orifice 445 and extending into the interior volume 425 of beverage flavoring container 400 from outlet tubing 455.

Additionally, in this embodiment, a retaining device 460 is affixed to a bottom portion of lid section 435 so that retaining device 460 is suspended within an alcoholic beverage 430 when lid section 435 is affixed to beverage flavoring container 400. A cover portion 475 removably attached to lid section 435 is disposed adjacent an attachment region 480 of retaining device 460 to lid section 435. Once cover portion 475 is removed from lid section 435 (as shown in the deconstructed view of beverage flavoring container 400 of FIG. 4B), flavoring agents 405 may be added and/or removed from retaining device 460. In additional embodiments, lid section 435 may include multiple retaining devices and multiple cover portions 475 configured as described above.

In the embodiment shown (FIGS. 4A and 4B), a decoupling mechanism to detach cover portion 475 from lid section 435 includes a twist-lock mechanism including male-female threading 477 and an engageable grip section 479 (handle). In order to disengage the threads 477, the grip section 479 integrated into lid section 435 is engaged by a hand of an individual and rotated until the threads 477 disengage. In additional embodiments, the decoupling mechanism to detach cover portion 475 from lid section 435 includes any of: a twist-lock mechanism, clips, a push-button disengagement mechanism, threading, a barrel ring (ring compression mechanism), or a tri-clamp.

FIG. 4C illustrates a perspective view of a beverage flavoring container 400 including a retaining device 460 affixed to a cover portion 475 of a lid section 435 of the beverage flavoring container 400 in accordance with certain embodiments of the present disclosure. Beverage flavoring container 400 is substantially similar to beverage flavoring container 400 of FIGS. 4A and 4B; however, the retaining device 460 of FIGS. 4A and 4B has been substituted with retaining device 460 that is integrated with cover portion 475, as opposed to being affixed to lid section 435. As shown, beverage flavoring container 400 comprises a decoupling mechanism to detach cover portion 475 from lid section 435 (similar to beverage flavoring container 400 of FIGS. 4A and 4B) that includes a twist-lock mechanism including male-female threading 477 and an engageable grip section 479 (handle). The mechanism works similarly to the mechanism of beverage flavoring container 400 of FIGS. 4A and 4B, except that retaining device 460 is removed from beverage flavoring container 400 along with cover portion 475, as shown in FIG. 4D. As further shown in FIG. 4D, retaining device 460 includes an opening through which flavoring agents 405 may be inserted and removed.

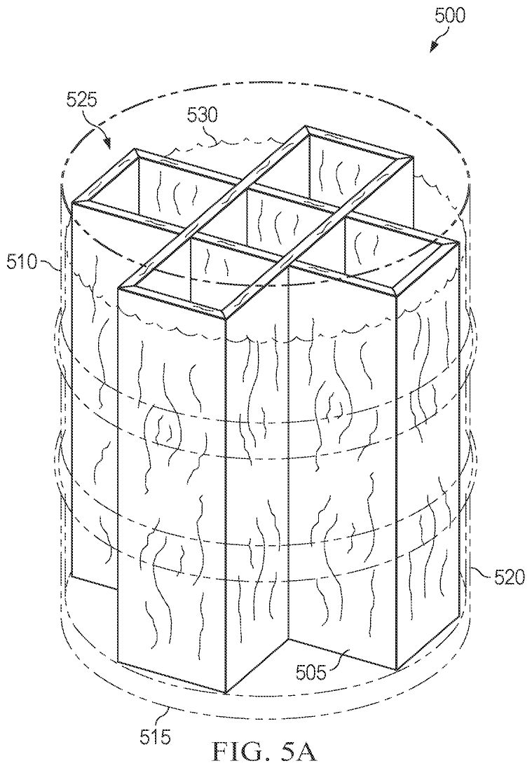

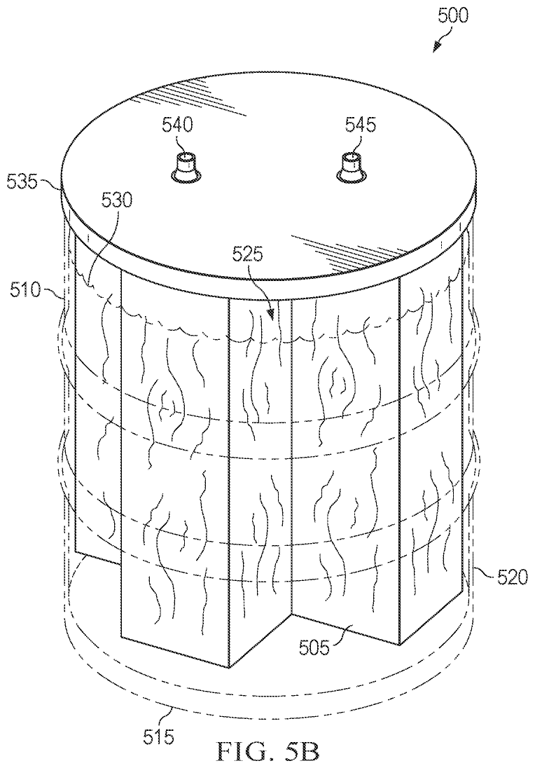

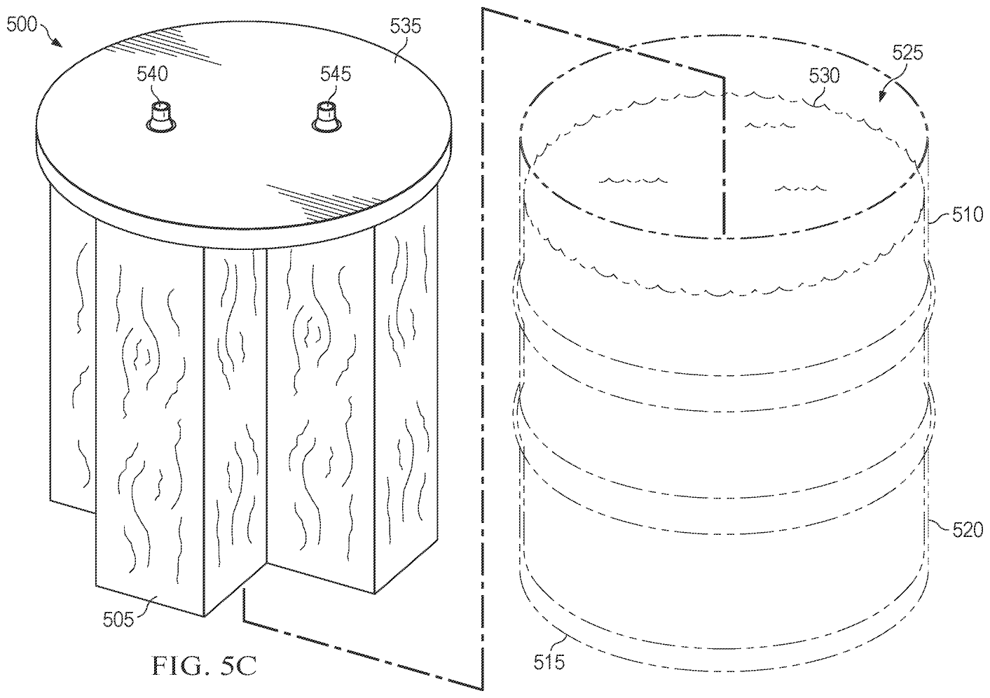

FIG. 5A is an illustration of a perspective view of an open beverage flavoring container 500 including an alternative flavoring agent 505 positioned in the alcoholic beverage container 500 in accordance with certain embodiments of the present disclosure. As shown, a majority of flavoring agent 505 is submerged within alcoholic beverage 530. Additionally, flavoring agent 505 is configured as a wood structure (including multiple pieces of wood) having a cross shape or X-shape (lattice configuration) that expands substantially the width and height of beverage flavoring container 500 in order to provide increased surface area exposure to alcoholic beverage 530 for flavoring purposes (in comparison to the flavoring agents previously presented). In an embodiment, flavoring agent 505 comprises a single type of wood. In an additional embodiment, flavoring agent 505 comprises more than one type of wood in order to provide additional/varied flavor characteristics to an alcoholic beverage. In further embodiments, on a lower end of flavoring agent 505 of FIG. 5A, leg portions may be formed by cutting out a middle portion of wood from each lower end of each piece of wood (for example, a square shape of wood cut out from each lower end of each piece of wood). This leg configuration may provide increased circulation of an alcoholic beverage within one or more interior spaces of the flavoring agent 505 disclosed in FIG. 5A.

FIG. 5B is an illustration of a perspective view of a beverage flavoring container 500 including an alternative flavoring agent 505 affixed to a lid section 535 and positioned in the alcoholic beverage container 500 in accordance with certain embodiments of the present disclosure. As shown, flavoring agent 505 is capable of flavoring an alcoholic beverage 530 in a closed environment as well as in an open environment (as shown in FIG. 5A). In this embodiment, flavoring agent 505 is affixed to lid section 535. In embodiments, flavoring agent 505 is affixed to lid section 535 via any of: an adhesive or a mechanical means (such as, for example, screws, or nails).

FIG. 5C is an illustration of a deconstructed view of a beverage flavoring container 500 including a lid section 535 and an alternative flavoring agent 505 removed from the beverage flavoring container 500 in accordance with certain embodiments of the present disclosure. As shown, lid section 535 and flavoring agent 505 are configured to be removed from beverage flavoring container 500 as a solitary unit.

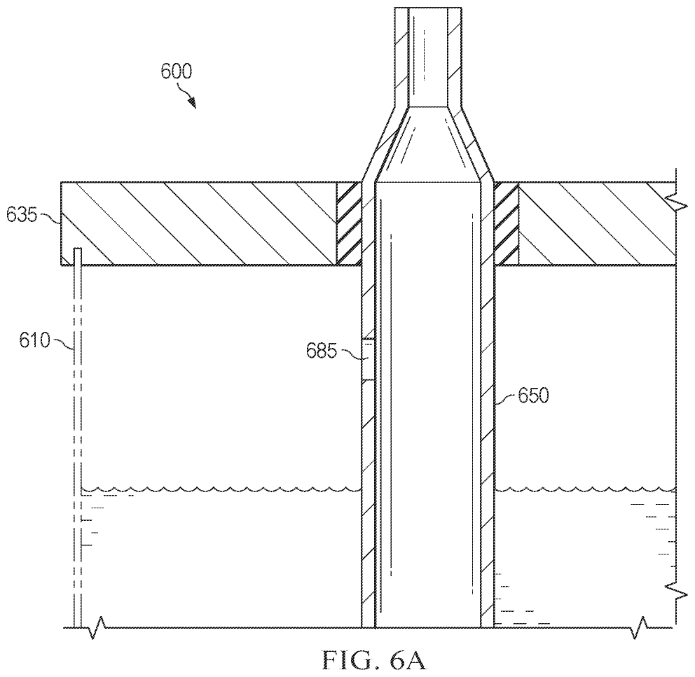

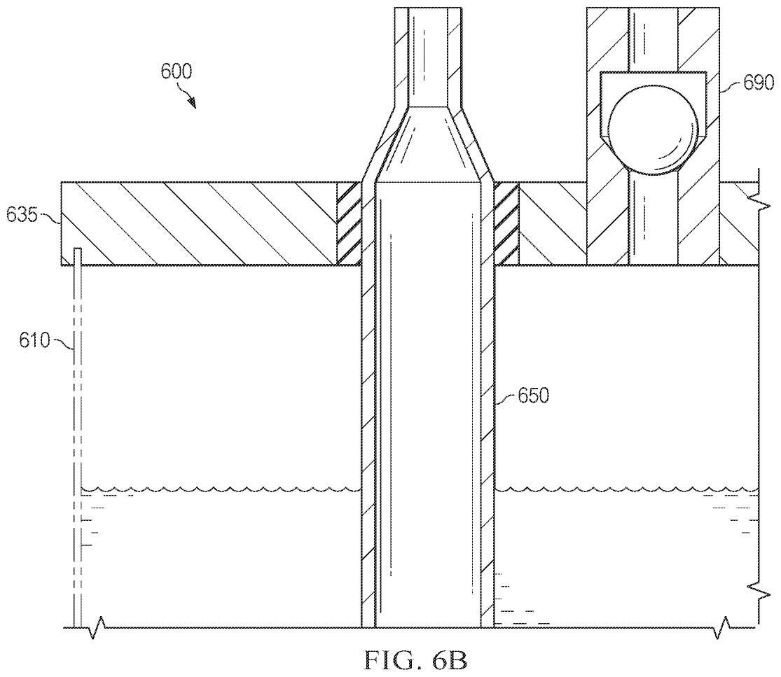

FIG. 6A is an illustration of a zoomed-in view of a beverage flavoring container 600 including an inlet tubing 650 having an orifice 685 in accordance with certain embodiments of the present disclosure. Orifice 685 is positioned to release gas buildup (pressure) in the inlet tubing 650 in order to reduce risk of damage to beverage flavoring container 600.

FIG. 6B is an illustration of a zoomed-in view of a beverage flavoring container 600 including a lid section 635 having an airlock 690 in accordance with certain embodiments of the present disclosure. Airlock 690 is positioned to release gas buildup (pressure) in the container body 610 in order to reduce risk of damage to beverage flavoring container 600.

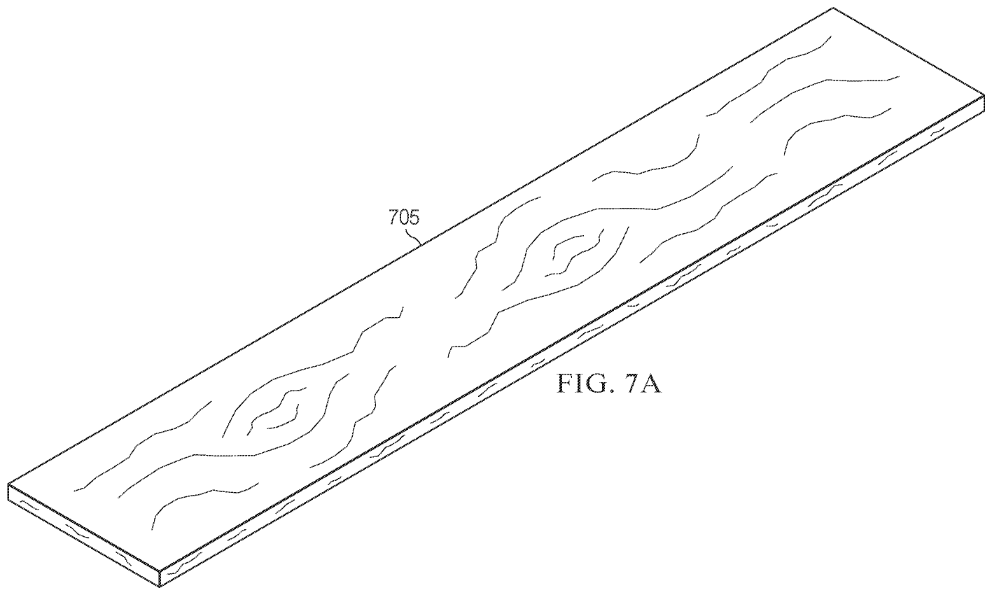

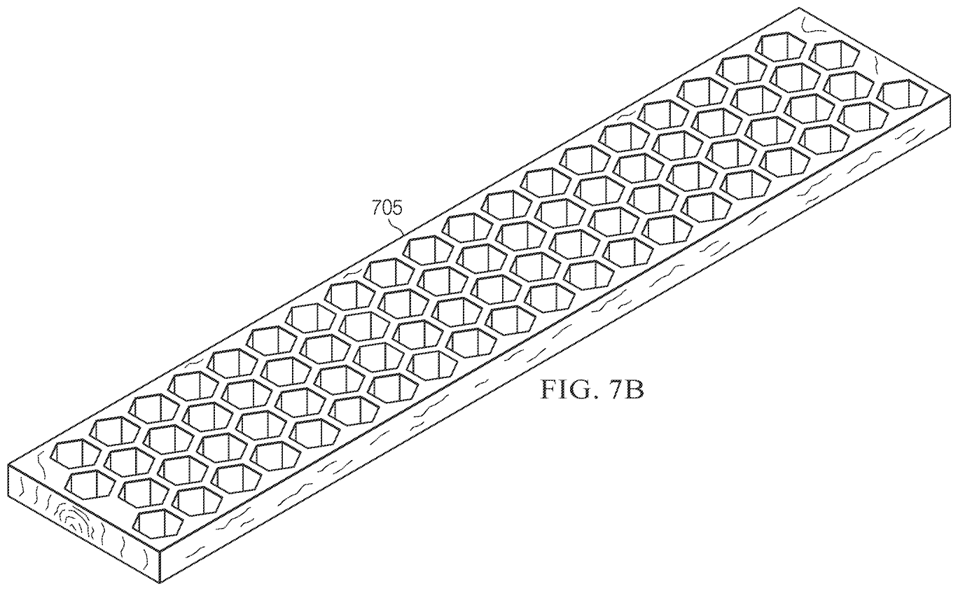

FIG. 7A is an illustration of a perspective view of a flavoring agent 705 in accordance with certain embodiments of the present disclosure. As shown, flavoring agent 705 is a piece of wood. As further shown in FIG. 7B, an alternative flavoring agent 705 (piece of wood) includes a lattice structure, and more specifically, a honeycomb configuration. The honeycomb configuration is configured to increase surface area exposure of the flavoring agent 705 to an alcoholic beverage. The increased surface area exposure may increase the flavoring agent's 705 ability to flavor an alcoholic beverage and therefore make the flavoring process of an alcoholic beverage shorter. In further embodiments, flavoring agent 705 may comprise any lattice structure that provides increased surface area exposure to an alcoholic beverage.

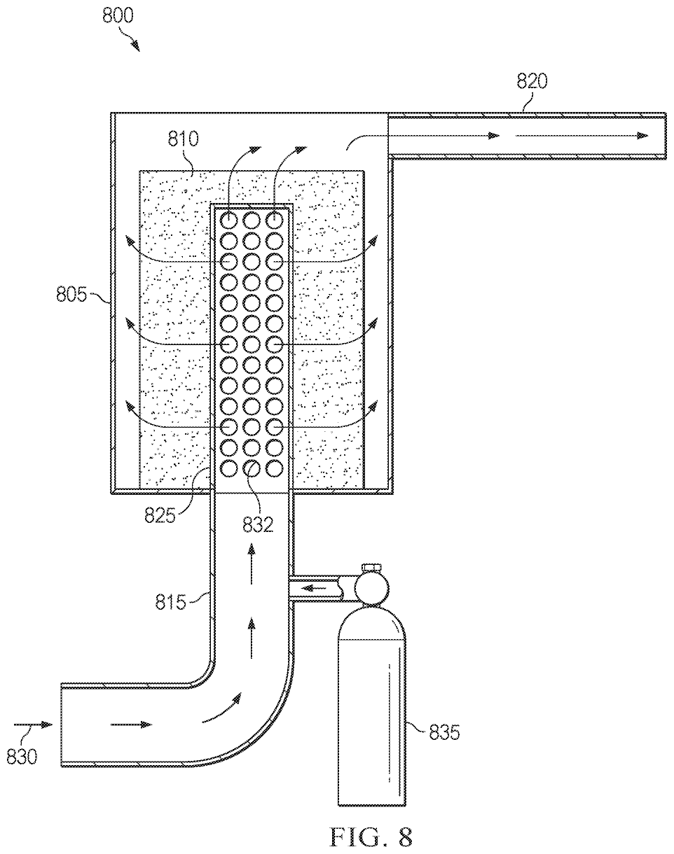

FIG. 8 is an illustration of a perspective view of a filter apparatus 800 for flavoring an alcoholic beverage 830 in accordance with certain embodiments of the present disclosure. As shown, filter apparatus 800 is configured to flavor an alcoholic beverage 830 in either liquid or vapor form. Filter apparatus 800 includes a housing 805 having a hollow interior. An inlet tubing 815 is affixed to an end of housing 805 and is configured to deliver the alcoholic beverage 830 (in vapor or liquid form) to internal tubing 825, which contains a plurality of orifices 832. Prior to the alcoholic beverage 830 entering internal tubing 825, oxygen device 835 may add oxygen to alcoholic beverage 830 in order to increase direct and/or indirect esterification within the alcoholic beverage 830 (and therefore alter the flavor profile of alcoholic beverage 830). In other embodiments, oxygen device 835 may be positioned at a different area on filter apparatus 800 or may be absent altogether.

The alcoholic beverage 830 then travels through internal tubing 825 and out orifices 832, where alcoholic beverage 830 is then forced into and travels through filter 810. In this case, filter 810 comprises one or more types of flavoring agents including sawdust, at least one type of wood chip, a piece of wood, a piece of wood in a lattice configuration, or a wooden lattice structure (embodied in, for example, flavoring agent 505) that are configured to provide molecules to alcoholic beverage 830 for the purpose of flavoring profile alteration. Once the alcoholic beverage 830 travels through filter 810, it continues to travel through outlet tubing 820. It is noted that in order to assist in propelling the alcoholic beverage 830 through filter 810, in an embodiment, a pump and/or vacuum may be utilized (not depicted).

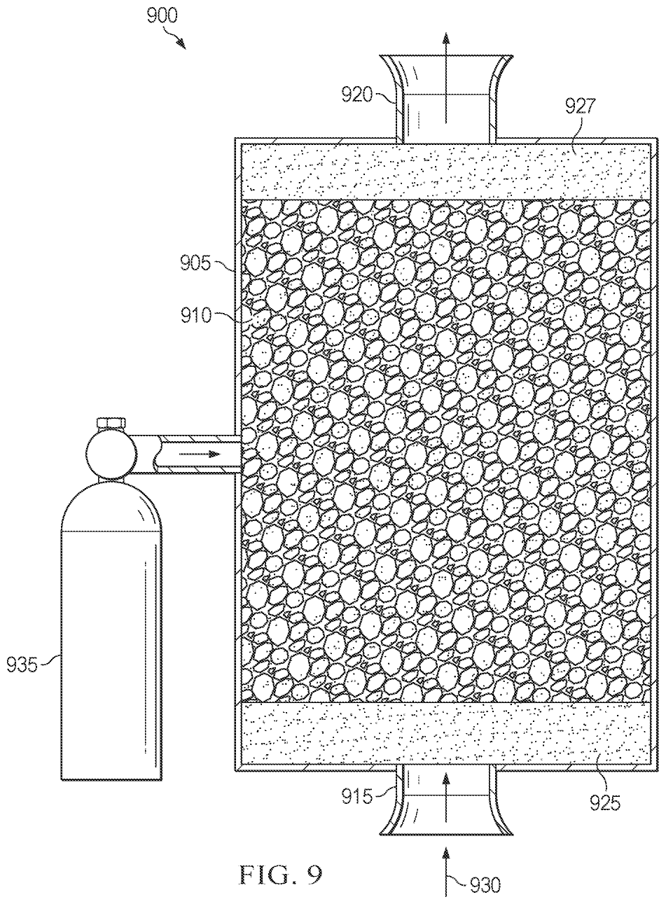

FIG. 9 is an illustration of a perspective view of an alternative filter apparatus 900 for flavoring an alcoholic beverage 930 in accordance with certain embodiments of the present disclosure. As shown, filter apparatus 900 may be configured as an inline filter apparatus and may be utilized in conjunction with a system for flavoring an alcoholic beverage in either liquid or vapor form. Filter apparatus 900 comprises a housing 905 housing an inline flavoring filter 910, which, in embodiments, comprises one or more types of flavoring agents including sawdust, at least one type of wood chip, a piece of wood, a piece of wood in a lattice configuration, or a wooden lattice structure (embodied in, for example, flavoring agent 505). Inline flavoring filter 910 is positioned between a first filter material 925 and a second filter material 927 each positioned on opposite ends of inline flavoring filter 910. When in use, the alcoholic beverage 930 (in the form of liquid or vapor) enters inlet 915 and is sent through housing 905, where alcoholic beverage 930 is filtered and flavored via contact with first filter material 925, second filter material 927, and inline flavoring filter 910. Once alcoholic beverage 930 is filtered and flavored, alcoholic beverage 930 exits housing 905 via outlet 920. In embodiments, either of first filter material 925 and a second filter material 927 may comprise a structure configured to filter out impurities from alcoholic beverage 930 when alcoholic beverage 930 is run through either of first filter material 925 or second filter material 927.

Additionally, oxygen device 935 may add oxygen to alcoholic beverage 930 in order to alter the flavor profile of alcoholic beverage 930. In other embodiments, oxygen device 935 may be positioned at a different area on filter apparatus 900 or may be absent altogether. It is noted that in order to assist in propelling the alcoholic beverage 930 through inline flavoring filter 910, in an embodiment, a pump and/or vacuum may be utilized (not depicted).

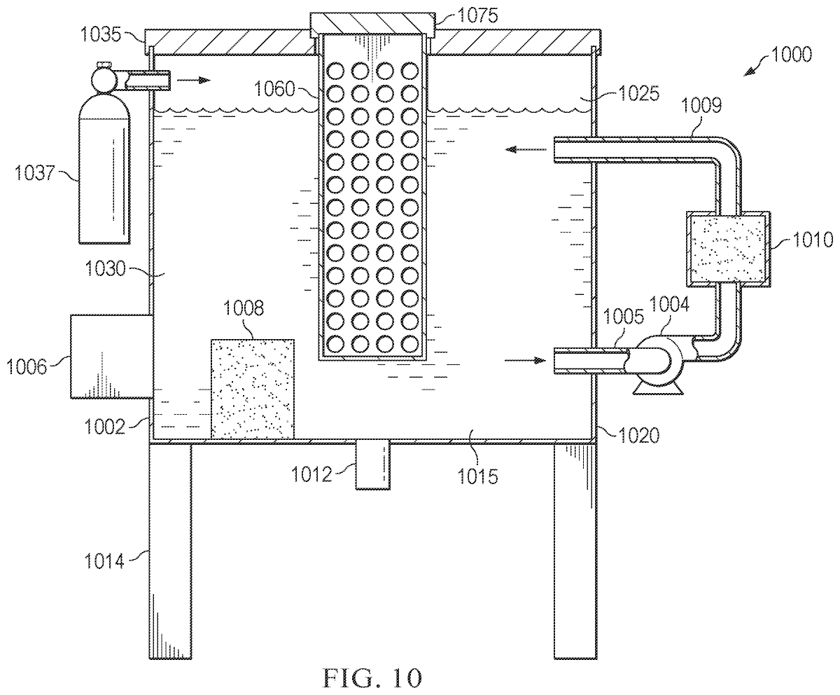

FIG. 10 is an illustration of a perspective view of an alternative beverage flavoring container 1000 including a retaining device 1060 affixed to a lid section 1035 of the beverage flavoring container 1000 in accordance with certain embodiments of the present disclosure. As shown, beverage flavoring container 1000 includes a body 1002 having an interior volume 1025. Body 1002 further includes a bottom section 1015, a sidewall 1020 disposed about a perimeter of the bottom section 1015, and a lid section 1035 affixed to the sidewall 1020. At least one retaining device 1060 is attached to lid section 1035 (more specifically, to cover portion 1075 that includes a similar functionality to cover portion 475 of FIGS. 4A-4D) and extends into the interior volume 1025 of beverage flavoring container 1000. Each of the at least one retaining device 1060 is configured to retain at least one flavoring agent (not depicted) for suspension of the at least one flavoring agent in alcoholic beverage 1030 when beverage flavoring container 1000 is at least partially filled with alcoholic beverage 1030.

As shown, multiple means for flavoring alcoholic beverage 1030 is shown in conjunction with beverage flavoring container 1000. One example of a flavoring means includes one or more flavoring agents positioned within the at least one retaining device 1060 within beverage flavoring container 1000 (as described previously). Another flavoring means includes an inline flavoring filter 1010 (similar to inline flavoring filter 910 unless otherwise noted) indirectly affixed to beverage flavoring container 1000 and containing one or more flavoring agents. Inline flavoring filter 1010 is affixed to an inlet tubing 1005 (including a pump 1004 for propelling the alcoholic beverage 1030 through the inline flavoring filter 1010) and an outlet tubing 1009 connecting inline flavoring filter 1010 to beverage flavoring container 1000. An additional flavoring means includes a solitary filter 1008 that comprises one or more configurations of a flavoring agent in the form of at least one of sawdust, at least one type of wood chip, a piece of wood, a piece of wood in a lattice configuration, or a wooden lattice structure (including multiple pieces of wood). An additional flavoring means includes oxygen device 1037 that may add oxygen to alcoholic beverage 1030 in order to alter the flavor profile of alcoholic beverage 1030 (as discussed previously). In an embodiment, beverage flavoring container 1000 includes one or more of the flavoring means disclosed.

Beverage flavoring container 1000 further includes a heating/cooling unit 1006 positioned on beverage flavoring container 1000. Heating/cooling unit 1006 may be utilized to adjust the temperature within beverage flavoring container 1000 and may comprise any of: an electromantle, an electric heating unit, a furnace, a propane/natural gas tank, a radiator/fan unit, a heat pump, an evaporative air conditioner, a water jacket, a heating/cooling jacket, a heat sink, or a steam device. A valve 1012 is affixed to bottom section 1015 and is configured to release alcoholic beverage 1030 from beverage flavoring container 1000 for purposes of disposal or moving alcoholic beverage 1030 to a different beverage flavoring container 1000. Legs 1014 are also affixed to bottom section 1015 of beverage flavoring apparatus 1000 and are configured to support beverage flavoring container 1000.

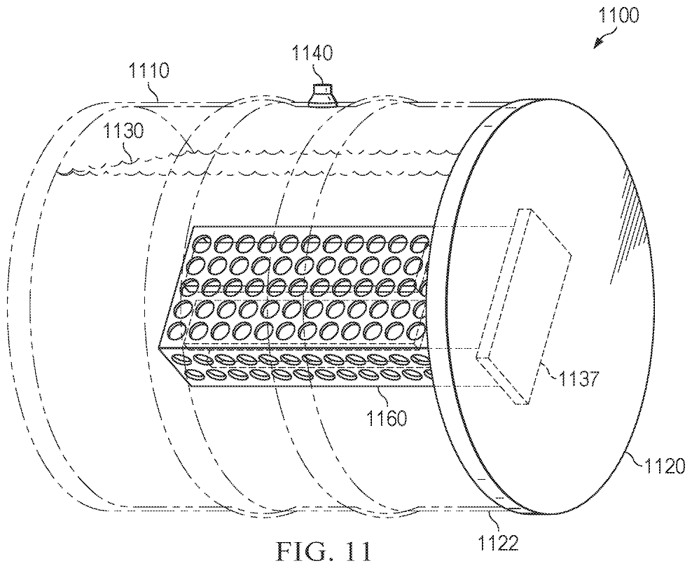

FIG. 11 is an illustration of a perspective view of an alternative beverage flavoring container 1100 in accordance with certain embodiments of the present disclosure. As shown, beverage flavoring container 1100 is configured as having a greater length than height and includes at least some elements that are similar to elements of other disclosed beverage flavoring containers. Beverage flavoring container 1100 includes a body 1110 housing an alcoholic beverage 1130. A retaining device 1160 is affixed to an end 1120 and retains at least one flavoring agent (not depicted) within alcoholic beverage 1130. A dual inlet/outlet 1140 is positioned within a sidewall 1122 and is configured for the insertion or extraction of alcoholic beverage 1130. In an embodiment, a lid section and/or cover portion 1137 (may be similar to any of lid sections/cover portions disclosed) may be positioned adjacent retaining device 1160 on end 1120 in order to remove at least one of retaining device 1160 or flavoring agent(s) from beverage flavoring container 1100 when lid section and/or cover portion 1137 is/are removed.

### Example Processes

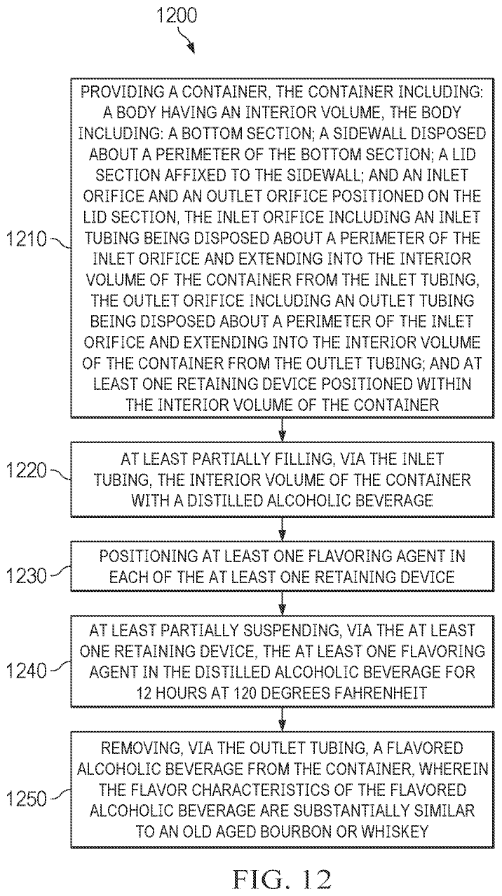

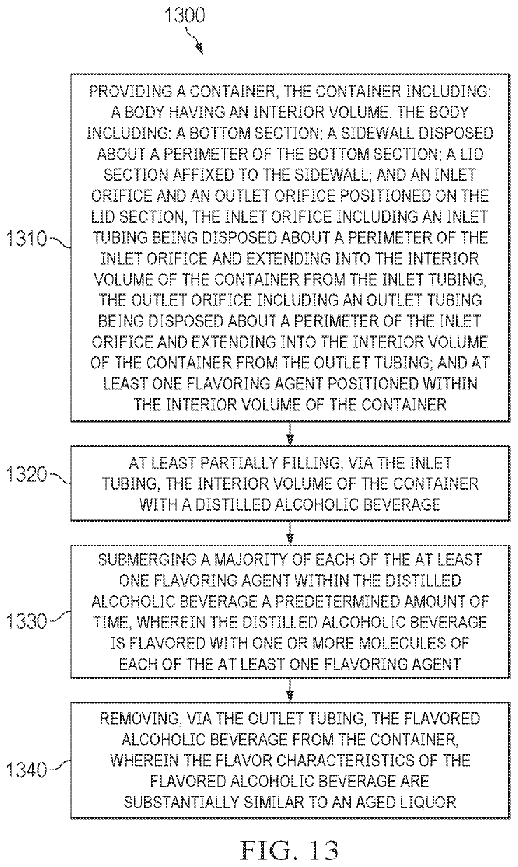

With the foregoing overview of the example containers, it may be helpful to consider a high-level discussion of example processes. To that end, FIGS. 12 and 13 are illustrations of flowcharts presenting methods 1200,1300 for flavoring an alcoholic beverage in accordance with certain embodiments of the present disclosure. The flowcharts are illustrated as processes in logical flowchart formats. The order in which the operations are described are not intended to be construed as limitations, and any number of the described processes can be combined in any order and/or performed in parallel to implement the processes. For discussion purposes, the methods 1200,1300 for flavoring an alcoholic beverage are described with reference to the configuration of containers 200, 300, 400 of FIGS. 2A-2C, 3, and 4A-4D. It is further noted that the implementation of method 1200 forms a flavored alcoholic beverage having flavor characteristics that are substantially similar to an old aged bourbon/whiskey.

At block 1210, a beverage flavoring container 200 is provided. Beverage flavoring container 200 includes a body 210 having an interior volume 225, where the body 210 includes a bottom section 215, a sidewall 220 disposed about a perimeter of the bottom section 215, and a lid section 235 affixed to the sidewall 220. The body 210 further includes an inlet orifice 240 and an outlet orifice 245 positioned on the lid section 235, where the inlet orifice includes an inlet tubing 250 being disposed about a perimeter of the inlet orifice 240 and extending into the interior volume 225 of the beverage flavoring container 200 from the inlet tubing 250, further where the outlet orifice 245 includes an outlet tubing 255 being disposed about a perimeter of the inlet orifice 240 and extends into the interior volume 225 of the beverage flavoring container 200 from the outlet tubing 255. The container further includes at least one retaining device 360 attached to the lid section 235 and extends into the interior volume 225 of the beverage flavoring container 200.

At block 1220, interior volume 225 of beverage flavoring container 300 is at least partially filled, via an inlet tubing 250, with a distilled alcoholic beverage (unflavored alcoholic beverage 230).

At block 1230, at least one flavoring agent 205 is positioned in each of the at least one retaining device 360.

At block 1240, the at least one flavoring agent 205 is at least partially suspended, via the at least one retaining device 360, in the distilled alcoholic beverage for 12 hours at 120 degrees Fahrenheit.

At block 1250, a flavored alcoholic beverage 230 is removed, via an outlet tubing 255, from beverage flavoring container 200, where the flavor characteristics of the flavored alcoholic beverage 230 are substantially similar to an old aged bourbon or whiskey.

In an embodiment, the at least one flavoring agent 205 includes a surface area substantially eight times that of an interior surface area of a traditional alcohol aging barrel.

In an embodiment, a configuration of each of the at least one flavoring agent comprises at least one of: sawdust, at least one type of wood chip, a piece of wood, a piece of wood in a lattice configuration, or a wooden lattice structure.

Reference is now made to FIG. 13, which is an illustration of a flowchart presenting an alternative method 1300 for flavoring an alcoholic beverage in accordance with certain embodiments of the present disclosure. It is noted that the implementation of method 1300 forms a flavored alcoholic beverage having flavor characteristics that are substantially similar to an aged liquor.

At block 1310, a beverage flavoring container 200 is provided. Beverage flavoring container 200 includes a body 210 having an interior volume 225, where the body 210 includes a bottom section 215, a sidewall 220 disposed about a perimeter of the bottom section 215, and a lid section 235 affixed to the sidewall 220. The body 210 further includes an inlet orifice 240 and an outlet orifice 245 positioned on the lid section 235, where the inlet orifice includes an inlet tubing 250 are disposed about a perimeter of the inlet orifice 240 and extend into the interior volume 225 of the beverage flavoring container 200 from the inlet tubing 250, further where the outlet orifice 245 includes an outlet tubing 255 disposed about a perimeter of the inlet orifice 240 and extends into the interior volume 225 of the beverage flavoring container 200 from the outlet tubing 255. The container further includes at least one flavoring agent 205 positioned within the interior volume 225 of the beverage flavoring container 200.

At block 1320, interior volume 225 of container 300 is at least partially filled, via an inlet tubing 250, with a distilled alcoholic beverage (unflavored alcoholic beverage 230).

At block 1330, a majority of each of the at least one flavoring agent 205 are submerged within the distilled alcoholic beverage a predetermined amount of time, where the distilled alcoholic beverage is flavored with one or more molecules of each of the at least one flavoring agent 205.

At block 1340, a flavored alcoholic beverage 230 is removed, via an outlet tubing 255, from beverage flavoring container 200, where the flavor characteristics of the flavored alcoholic beverage are substantially similar to an aged liquor.

In an embodiment, the at least one flavoring agent 205 includes a surface area substantially four times that of an interior surface area of a traditional alcohol aging barrel.

In an embodiment, each of the at least one flavoring agent 205 are retained in at least one retaining device 260 during the submerging.

In an embodiment, the submerging of the majority of each of the at least one flavoring agent 205 within the distilled alcoholic beverage is performed for 18 hours at 100 degrees Fahrenheit.

In an embodiment, the aged liquor is a four to six year bourbon or whiskey.

In an embodiment, a configuration of each of the at least one flavoring agent 205 comprises at least one of: sawdust, at least one type of wood chip, a piece of wood, a piece of wood in a lattice configuration, or a wooden lattice structure.

In any of the disclosed embodiments, flavoring agents are configured to release molecules into an alcoholic beverage that are configured to provide flavor to the alcoholic beverage.

In any of the disclosed embodiments, a configuration of a flavoring agent comprises at least one of: sawdust, at least one type of wood chip, a piece of wood, a piece of wood in a lattice configuration, or a wooden lattice structure.

It is noted that any of the terms “alcoholic beverage”, “distilled alcoholic beverage”, or “unflavored alcoholic beverage” may refer to an alcoholic beverage that has not absorbed molecules from a flavoring agent. In an embodiment, an alcoholic beverage may be a distilled alcoholic beverage that is utilized in any of the disclosed systems or methods relative to flavoring an alcoholic beverage. In a further embodiment, an alcoholic beverage may be an undistilled alcoholic beverage that is utilized in any of the disclosed systems or methods relative to flavoring an alcoholic beverage.

It is noted that by virtue of the configuration of any of the disclosed beverage flavoring containers, the “angel's share” (which is the evaporated portion of an alcoholic beverage from a traditional barrel) is eliminated, which saves roughly between 20 to 30 percent of an alcoholic beverage. An additional benefit of this elimination includes a reduction in black mold formation due to the evaporated ethanol in the environment (surrounding the traditional barrel/containers disclosed). It is further noted that because the “angel's share” is eliminated, the processes of flavoring an alcoholic beverage can be considered one or more of an: emissions-free process, an eco-friendly process, a “green” process, a net-zero process, and/or a high fire safety rating process.

It is noted that by virtue of the configuration of the disclosed flavoring agents being wood, a much smaller volume of wood can be utilized to flavor an alcoholic beverage, as opposed to a traditional alcohol aging barrel.

In an embodiment, a flavoring agent 705 (pieces of wood) of any of the disclosed embodiments comprises a plain sawn configuration. By virtue of this configuration, a liquid (an alcoholic beverage) is able to penetrate and flow through the pieces of wood more easily than other cuts of wood such as, for example, quarter sawn. In additional embodiments, a flavoring agent (pieces of wood) of any of the disclosed embodiments comprises any of: a flat sawn configuration, a quarter sawn configuration, a half sawn configuration, a rift sawn configuration, or a live sawn configuration.

In an embodiment, a container body of any of the disclosed embodiments that is filled with an alcoholic beverage may house more than one type of flavoring agent (more than one type of wood pieces). By virtue of this feature, more specific and/or unique flavor profiles can be created within a single alcoholic beverage.

In an embodiment, an alcoholic beverage of any of the disclosed embodiments comprises a liquor, such as, but not limited to: whiskey, brandy, rum, gin, vodka, or tequila. In an additional embodiment, an alcoholic beverage of any of the disclosed embodiments comprises any of liqueurs, wine, beer, sake, mead, or hard cider.

It is noted that a container body of any of the disclosed embodiments can include one or more materials configured to provide certain end characteristics for the container as a whole (when the interior volume of the containers is fully encapsulated). In an embodiment, a container body of any of the disclosed embodiments comprises metal. In further embodiments, a container body of any of the disclosed embodiments comprises stainless steel. In further embodiments, a container body of any of the disclosed embodiments comprises polycarbonate or any other hard plastic. In further embodiments, a container body of any of the disclosed embodiments comprises a material that embodies a density to reduce/limit evaporation and/or leakage (reduced/limited penetration of the material by a gas/liquid when a gas/liquid is fully enclosed within the container body). In further embodiments, a container body of any of the disclosed embodiments comprises a material that is configured to be pressure controlled (withstand an inner volume of gas and/or liquid in the container body during changes in pressure). In further embodiments, a container body of any of the disclosed embodiments comprises a material that is configured to be temperature controlled (withstand heat applied to the container body). In further embodiments, a container body of any of the disclosed embodiments comprises a material that is configured to be substantially corrosion resistant (in regards to what the container is filled with). By virtue of the material configuration, any of the previously disclosed embodiments include a greater fire safety rating than a traditional alcohol aging barrel.

It is noted that when a filter of any of the embodiments disclosed includes a flavoring agent with a lattice structure, the flavoring agent with a lattice structure may be similar to the configuration of flavoring agent 505 but on a smaller scale. Additionally, any orifices relative to the lattice structure may be filled via at least one of wood chips or sawdust.

In an embodiment, a container body of any of the disclosed embodiments comprises a tank structure. In further embodiments, a container body of any of the disclosed embodiments comprises any of an open top tank configuration, a seal tank configuration, or a tank with an unsealed lid.

In any embodiments including a beverage flavoring container and a lid section, a lid section may not extend to a sidewall of a beverage flavoring container and may be smaller than a circumference/perimeter of the beverage flavoring container. As an example, a beverage flavoring container comprises a capacity of 10,000 gallons and includes a lid section having a width of three feet.

In an embodiment, a retaining device of any of the disclosed embodiments is substantially metal. In further embodiments, a retaining device of any of the disclosed embodiments comprises stainless steel.

In an embodiment, an inlet tubing and/or an outlet tubing of any of the disclosed embodiments is substantially metal. In further embodiments, an inlet tubing and/or an outlet tubing of any of the disclosed embodiments comprises stainless steel.

In any of the disclosed embodiments, one of an inlet (orifice) or an outlet (orifice) may be utilized as an inlet (orifice) and an outlet (orifice).

In any of the disclosed embodiments, beverage flavoring containers may be stored on racks similarly to the setup of barrels in a rickhouse. In this case, a lid section or open end may be positioned within a sidewall of a beverage flavoring container.

In any of the disclosed embodiments, the molecules in a flavoring agent may comprise one or more of: lactones, aldehydes, esters, phenolic compounds (such as, for example, polyphenols and/or volatile phenols), tannins, terpenes, lignins, cellulose, hemicellulose, acids, and/or sugars.

In any of the disclosed embodiments including a container and one or more filters, any of the filters associated with a container may be positioned in areas within or on the container, where the areas may include one or more of: a lid section of a container, a top (of a lid section or a container), an interior or an exterior side of a container, and/or a bottom of a container.

In any of the disclosed embodiments including at least one of a lid section or a cover portion, the lid section and/or cover portion may be affixed to a respective beverage flavoring container/lid section via any of: a twist-lock mechanism, clips, a push-button disengagement mechanism, threading, a barrel ring (ring compression mechanism), or a tri-clamp.

In any of the disclosed embodiments including at least one of a flavoring agent(s) or a filter(s), the flavoring agent(s) and/or filter(s) may be inserted within a beverage flavoring container prior to adding an alcoholic beverage.

In any of the disclosed embodiments including at least one of a flavoring agent(s) or a filter(s), the flavoring agent(s) and/or filter(s) may be enclosed within a mesh bag.

In any of the disclosed embodiments including at least one of a flavoring agent(s) or a filter(s), the flavoring agent(s) and/or filter(s) may be positioned on a rack within a beverage flavoring container.

In any of the disclosed embodiments including at least one of a flavoring agent(s) or a filter(s), the flavoring agent(s) and/or filter(s) may be removed from a beverage flavoring container via an opening in a bottom section of a beverage flavoring container.

In any of the disclosed embodiments including at least one retaining device each including at least one flavoring agent, the retaining devices may be placed on a bottom section of the beverage flavoring container.

In any of the disclosed embodiments including a container, any portion of a container may comprise a wood structure (including lid sections) in order to allow for natural oxygenation of an alcoholic beverage.

In any of the disclosed embodiments including a flavoring agent comprising some type of wood structure, the wood may comprise one or more of the following types of wood: oak, elm, beech, cherry, chestnut, and/or ash.

In any of the disclosed embodiments including a container, an inert gas may be utilized to increase esterification within an alcoholic beverage (adding to the flavor profile). Inert gases may include, but are not limited to: oxygen or nitrogen.

In any of the disclosed embodiments, air may be purged out of a beverage flavoring container. In further embodiments, air may be purged out of a beverage flavoring container via a vacuum pump.

For the purposes of this disclosure, the terms “beverage flavoring container” and “container” may be synonymous.

For the purposes of this disclosure, a container of any of the disclosed embodiments is configured to induce an “aging” process of an alcoholic beverage, which, in relation to this application, may be considered a flavoring session. In an embodiment, the aging process is performed between 24 and 48 hours (configured to be more “rapid” than the traditional “aging” process).

For the purposes of this disclosure, the term “flavoring” may be understood as the process of an alcoholic beverage, as disclosed, absorbing molecules from a flavoring agent. This process may also be referred to as “infusion”, “diffusion”, “aging”, and/or “maturation”.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the description herein.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

The above-disclosed embodiments have been presented for purposes of illustration and to enable one of ordinary skill in the art to practice the disclosure, but the disclosure is not intended to be exhaustive or limited to the forms disclosed. Many insubstantial modifications and variations will be apparent to those of ordinary skill in the art without departing from the scope and spirit of the disclosure. The scope of the claims is intended to broadly cover the disclosed embodiments and any such modification. Further, the following clauses represent additional embodiments of the disclosure and should be considered within the scope of the disclosure:

Clause 1, a container for flavoring an alcoholic beverage, the container comprising: a body having an interior volume, the body including: a bottom section; a sidewall disposed about a perimeter of the bottom section; and a lid section affixed to the sidewall; and at least one flavoring agent positioned within the interior volume of the container.

Clause 2, the container of Clause 1, further comprising at least one retaining device positioned within the interior volume of the container, wherein each of the at least one retaining device is configured to retain one or more of the at least one flavoring agent for suspension of the at least one flavoring agent in the alcoholic beverage when the container is at least partially filled with the alcoholic beverage.

Clause 3, the container of Clause 1, wherein the body comprises a tank structure.

Clause 4, the container of Clause 1, wherein each of the at least one retaining device comprises at least one orifice configured to expose each of the at least one flavoring agent to the alcoholic beverage.

Clause 5, the container of Clause 1, further comprising a pressure release mechanism positioned on the lid section.

Clause 6, the container of Clause 1, further comprising at least one cover portion removably attached to the lid section.

Clause 7, the container of Clause 6, wherein each of the at least one removable cover is disposed adjacent an attachment region of a respective one of the at least one retaining device to the lid section.

Clause 8, the container of Clause 7, wherein each of the at least one removable cover is integral with a respective one of the at least one retaining device.

Clause 9, the container of Clause 7, wherein at least one of the at least one retaining device is affixed to the lid section.

Clause 10, the container of Clause 1, wherein a configuration of the at least one flavoring agent comprises at least one of: sawdust, at least one type of wood chip, a piece of wood, a piece of wood in a lattice configuration, or a wooden lattice structure.

Clause 11, the container of Clause 10, wherein each of the at least one piece of wood comprises a honeycomb configuration, the honeycomb configuration configured to increase surface area exposure of each of the at least one piece of wood to the alcoholic beverage.

Clause 12, a filter apparatus for flavoring an alcoholic beverage, the apparatus comprising: a housing; and a filter positioned within the housing; wherein the filter comprises at least one flavoring agent configured to release molecules into the alcoholic beverage that are configured to provide flavor to the alcoholic beverage.

Clause 13, the apparatus of Clause 12, wherein a configuration of the at least one flavoring agent comprises at least one of: sawdust, at least one type of wood chip, a piece of wood, a piece of wood in a lattice configuration, or a wooden lattice structure.

Clause 14, the apparatus of Clause 12, wherein the filter apparatus is configured as an inline filter apparatus including an inlet portion and an outlet portion.

Clause 15, the apparatus of Clause 14, further comprising an oxygen device for providing oxygen to at least one of: the filter, the inlet portion, or the outlet portion.

What is claimed is:

1. A container for flavoring an alcoholic beverage, the container comprising:
a body having an interior volume, the body including:
a bottom section;
a sidewall disposed about a perimeter of the bottom section; and
a lid section affixed to the sidewall;
and
at least one flavoring agent positioned within the interior volume of the container.

2. The container of claim 1, further comprising at least one retaining device positioned within the interior volume of the container, wherein each of the at least one retaining device is configured to retain one or more of the at least one flavoring agent for suspension of the at least one flavoring agent in the alcoholic beverage when the container is at least partially filled with the alcoholic beverage.

3. The container of claim 1, wherein the body comprises a tank structure.

4. The container of claim 1, wherein each of the at least one retaining device comprises at least one orifice configured to expose each of the at least one flavoring agent to the alcoholic beverage.

5. The container of claim 1, further comprising a pressure release mechanism positioned on the lid section.

6. The container of claim 1, further comprising at least one cover portion removably attached to the lid section.

7. The container of claim 6, wherein each of the at least one removable cover is disposed adjacent an attachment region of a respective one of the at least one retaining device to the lid section.

8. The container of claim 7, wherein each of the at least one removable cover is integral with a respective one of the at least one retaining device.

9. The container of claim 7, wherein at least one of the at least one retaining device is affixed to the lid section.

10. The container of claim 1, wherein a configuration of the at least one flavoring agent comprises at least one of: sawdust, at least one type of wood chip, a piece of wood, a piece of wood in a lattice configuration, or a wooden lattice structure.

11. The container of claim 10, wherein each of the at least one piece of wood comprises a honeycomb configuration, the honeycomb configuration configured to increase surface area exposure of each of the at least one piece of wood to the alcoholic beverage.

12. A filter apparatus for flavoring an alcoholic beverage, the apparatus comprising:
a housing; and
a filter positioned within the housing;
wherein the filter comprises at least one flavoring agent configured to release molecules into the alcoholic beverage that are configured to provide flavor to the alcoholic beverage.

13. The apparatus of claim 12, wherein a configuration of the at least one flavoring agent comprises at least one of: sawdust, at least one type of wood chip, a piece of wood, a piece of wood in a lattice configuration, or a wooden lattice structure.

14. The apparatus of claim 12, wherein the filter apparatus is configured as an inline filter apparatus including an inlet portion and an outlet portion.

15. The apparatus of claim 14, further comprising an oxygen device for providing oxygen to at least one of: the filter, the inlet portion, or the outlet portion.
